(19) United States
(12) Patent Application Publication
(10) Pub. No.: US 2024/0406118 A1
(43) Pub. Date: Dec. 5, 2024

(54) METHOD AND APPARATUS FOR SCHEDULING

(71) Applicant: ELECTRONICS AND TELECOMMUNICATIONS RESEARCH INSTITUTE, Daejeon (KR)

(72) Inventors: Ju Hyeok KWON, Seoul (KR); Jinoo Joung, Seoul (KR); Jeong Dong Ryoo, Daejeon (KR); Tae Sik Cheung, Daejeon (KR)

(21) Appl. No.: 18/677,506

(22) Filed: May 29, 2024

(30) Foreign Application Priority Data
May 30, 2023 (KR) 10-2023-0069361

(51) Int. Cl. H04L 47/6295; H04L 47/2441

(52) U.S. Cl. CPC H04L 47/6295; H04L 47/2441

(57) ABSTRACT

A method and apparatus for scheduling are disclosed. An apparatus for packet scheduling includes a flow type classifier configured to classify a flow by type and to allocate at least one queue to each flow type; and a scheduler configured to calculate finish times of packets in the queue and to compare finish times of HoQ packets in the queue with each other to output an HoQ packet with an earliest finish time.

### CROSS-REFERENCE TO RELATED APPLICATION

This application claims priority to Korean Patent Application No. 10-2023-0069361, filed on May 30, 2023 in the Korea Intellectual Property Office, the entire contents of which are incorporated herein by reference.

### TECHNICAL FIELD

The present disclosure relates to an apparatus and method for scheduling. More specifically, the present disclosure relates to an apparatus and method for FIFO queue-based work conserving fair queuing scheduling for each flow type that does not require flow status information from a core node.

### BACKGROUND

The statements in this section merely provide background information related to the present disclosure and do not necessarily constitute prior art.

The amount of data transmitted using communication networks is increasing. When transmitting a huge amount of data, a method of guaranteeing Quality of Service (QoS), that is, scheduling of packets, is required.

To guarantee QoS or delay time, a flow should be protected. The flow refers to a set of packets that have the same source and destination and are generated by the same application. There is a fair queuing method as a scheduling algorithm for flow protection. The fair queuing is a scheduling method that processes the processing order of packets fairly. For example, fair queuing ensures that a flow with a large packet does not consume more throughput or CPU time than other flows.

The fair queuing methods include weighted fair queuing (hereinafter, referred to as “WFQ”) and Packetized generalized processor sharing (PGPS). These methods are scheduling algorithms that calculate a service finish time of a packet and transmit the packet using the service finish time. These methods are virtually impossible to implement in a core node because the node should maintain status, such as the finish time, for each flow. To solve this problem, a method to estimate the finish time has been proposed. This method is called core-stateless fair queuing (hereinafter, referred to as “CSFQ”).

The conventional CSFQ has the disadvantage of being difficult to implement because it has to maintain a queue for each flow, and operating in a non-work conserving manner, resulting in a large average delay time. The recently proposed work conserving stateless fair queuing uses the finish time at an entrance node as packet metadata. The work conserving stateless fair queuing operates as work conserving while maintaining only the queue for each input port. The work conserving means trying to keep resources busy at all times when there is work to be done. Due to the nature of the work conserving, the order of finish times and arrival times may be different, thus causing a problem in which service of packets with small finish times is delayed due to head of queue (hereinafter, referred to as “HoQ”) packets. As a result, work conserving CSFQ operates on a per input/output port pair basis, weakening flow protection. To solve this problem, a push-in first-out (hereinafter, referred to as “PIFO”) queue may be used, but the use of PIFO may be a factor that increases the difficulty of implementing CSFQ.

### SUMMARY

The purpose of this disclosure is to provide a scheduling device that is simple to implement and can protect flows.

Technical objects to be achieved by the present disclosure are not limited to those described above, and other technical objects not mentioned above may also be clearly understood from the descriptions given below by those skilled in the art to which the present disclosure belongs.

An embodiment of the present disclosure provides an apparatus for packet scheduling, the apparatus comprising: a flow type classifier configured to classify a flow by type and to allocate at least one queue to each flow type; and a scheduler configured to calculate finish times of packets in the queue and to compare finish times of HoQ packets in the queue with each other to output an HoQ packet with an earliest finish time.

Another embodiment of the present disclosure provides a method for packet scheduling by a scheduling apparatus, the method comprising: classifying at least one flow by type; allocating at least one queue to each flow type; calculating a finish time of each packet in the queue; and comparing finish times of HoQ packets in the queue and transmitting a HoQ packet with an earliest finish time.

According to an embodiment of the present disclosure, a scheduling device that is simple to implement and can protect flows can be provided by classifying flows by type and allocating one queue to each flow type.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 is a schematic block diagram of a network relay node according to one embodiment of the present disclosure.

FIG. 2 is a flow chart illustrating a scheduling method according to one embodiment of the present disclosure.

FIG. 3 illustrates a network configuration diagram according to one embodiment of the present disclosure.

FIG. 4 is a graph illustrating simulation results using the network configuration illustrated in FIG. 3.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

Singular terms may also include plural terms unless otherwise specified.

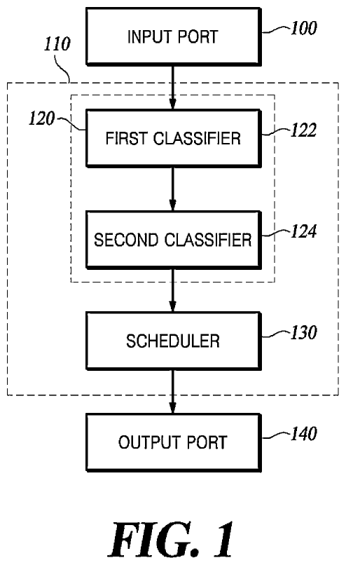

FIG. 1 is a schematic block diagram of a network relay node according to one embodiment of the present disclosure.

Referring to FIG. 1, the network relay node (hereinafter, referred to as “relay node”) of the present disclosure includes all or some of an input port 100, a scheduling device 110, and an output port 140.

The input port 100 receives data transmitted from other nodes. The data received by the input port 100 includes a flow and a packet.

The scheduling device 110 includes a flow type classifier 120 and/or a scheduler 130. The flow type classifier 120 classifies the flow of input data by type. The flow type can be classified according to classification criteria. For example, the classification criterion may be whether a maximum burst size and a service rate are similar to each other.

The flow type classifier 120 includes a first classifier 122 and a second classifier 124. The first classifier 122 classifies the flow based on a service rate. There can be various ways to classify the flow. For example, it can be classified into a flow with a service rate higher than a pre-determined value and a flow with a service rate equal to or lower than a pre-determined value. As another example, the flow may be classified into high, medium, or low levels using quality of service (QoS).

The second classifier 124 classifies the flow based on the maximum burst size. Like the first classifier 122, the second classifier 124 may also classify the flow using various methods. For example, it can be classified into a flow with a maximum burst size greater than a pre-determined value, and a flow with a maximum burst size equal to or smaller than a pre-determined value. As another example, the flow can be classified into high, medium, or low levels using QoS priority. That is, when the QoS has a priority level of 1 to 7, the flow type can be classified as high for levels 7 to 5, medium for levels 4 to 2, and low for levels 1 to 0.

The flow type classifier 120 may classify the flow using a method of giving low priority to the flow types that do not require the service rate and the maximum burst size, and giving high priority to the flow types that require the service rate and the maximum burst size. The flow type classifier 120 may provide a fair queuing service only to the flow to which a high priority is given. The flow type classifier 120 may provide a best effort service to the flow to which a low priority is given. Since the best effort service is well-known, a detailed description thereof will be omitted.

The flow type classifier 120 allocates one queue to each flow type. For example, each classified flow type may have one queue. That is, the number of flow types and the number of queues may be the same. By having one queue per flow type, the number of queues can be reduced compared to having one queue per flow. The queue of the present disclosure includes a work conserving FIFO (first in, first out) queue.

The scheduler 130 calculates a finish time of the packet entered into each queue and then compares the finish times of the HoQ packets in the queue. Here, the HoQ packet refers to a packet located at a head portion of each queue. The scheduler 130 outputs a HoQ packet with a small finish time. The finish time is calculated using a virtual clock. Since the virtual clock is already a known method, detailed explanation of the virtual clock will be omitted.

The scheduler 130 may calculate the finish time regardless of the time when the flow type classifier 120 classifies the flow by type. For example, the scheduler 130 may calculate the finish time at any selected time before the flow type classifier 120 classifies the flow by type, while the flow type classifier classifies the flow by type, or after the flow type classifier classifies the flow by type. For explanation purposes, the point in time when the scheduler 130 calculates the finish time is described as an example. However, the point at which the scheduler 130 calculates the finish time is not limited to this, and may be any point before the point at which the finish times of HoQ packets included in each queue are compared. The information required to calculate finish time is listed in Table 1.

TABLE 1

| Symbol | Description |
|---|---|
| pᵢ | Packet belongs to flow i |
| F, Fₕ | Finish time, finish time at node h |
| A, Aₕ | Arrival time, arrival time at node h |
| L | Maximum packet length of flow to which packet belongs |
| l | Packet length |
| Lmaxₕ | Maximum packet length of flows passing through node h |
| Rₕ | Link capacity of node |
| r | Service rate of flow to which packet belongs |
| d | Finish time update value |

The entrance node is a node different from the relay node in FIG. 1. The entrance node may be a node that receives packets from a source. The entrance node maintains the finish time, link capacity of the node, and maximum packet length values of flows passing through the node. The entrance node may record an arrival time (A₀) each time each packet arrives at the entrance node. The metadata of each packet includes a finish time (Fₕ), a maximum packet length (L) of the flow to which the packet belongs, a packet length (l), a service rate (r) of the flow, and finish time update value (d). The entrance node does not have a queue for each flow type. The entrance node has a queue for each flow.

The entrance node may calculate the finish time. The finish time calculated by the entrance node is called a global finish time. An algorithm by which the entrance node calculates the global finish time F₀(pᵢ) is as illustrated in Eq. 1.

$$\begin{matrix}{F}_{0} ( {p}_{i} ) = max ( {F}_{0} ( {p}_{i - 1} ) , {A}_{0} ( {p}_{i} ) ) + {p}_{i} . i / {p}_{i} . r \\ {p}_{i} . F = {F}_{0} ( {p}_{i} ) \\ if {p}_{i} . L > L {max}_{0} : L {max}_{0} = {p}_{i} . L \\ {p}_{i} . d = L {max}_{0} / {R}_{0} + {p}_{i} . L / {p}_{i} . r \\ {queue}_{i} . put ( {p}_{i} )\end{matrix} \qquad [ Eq . 1 ]$$

In Eq. 1, F₀(pᵢ) is the finish time recorded at the entrance node. pᵢ·F is the finish time recorded in the packet. The finish time update value pᵢ·d may be obtained using various methods. For example, pᵢ·d may be the sum of a maximum transmission delay at the entrance node and a maximum service latency of each flow. As another example, pᵢ·d may be the average delay time, a pre-determined constant value, or propagation delay.

The scheduler 130 of the relay node may update the finish time. The scheduler 130 updates the finish time using the finish time update value pᵢ·d obtained by the entrance node and the global finish time pᵢ·F. The algorithm for the scheduler 130 to update the finish time pᵢ·F is as illustrated in Eq. 2.

$$\begin{matrix}{p}_{i} . F = {p}_{i} . F + {p}_{i} . d \\ if {p}_{i} . L > L {max}_{h} : L {max}_{h} = {p}_{i} . L \\ {p}_{i} . d = L {max}_{h} / {R}_{h} + {p}_{i} . L / {p}_{i} . r \\ {queue}_{i} . put ( {p}_{i} )\end{matrix} \qquad [ Eq . 2 ]$$

The relay node maintains the maximum packet length of the flow passing through the node and the link capacity value.

The finish time update value pᵢ·d of the same flow is substantially a constant. The finish time update values pᵢ·d of each flow of the same flow type have similar values. Therefore, the updated finish time pᵢ·F only depends on the global finish time.

The global finish time is determined by the service rate and the maximum burst size. Therefore, when the flows are classified based on the service rate and the maximum burst size, the flows of the same type have similar global finish times.

In other words, in the relay node according to the present disclosure, the flows with similar finish times may be included in one queue.

The output port 140 transmits the packet transmitted by the scheduler 130 to other nodes.

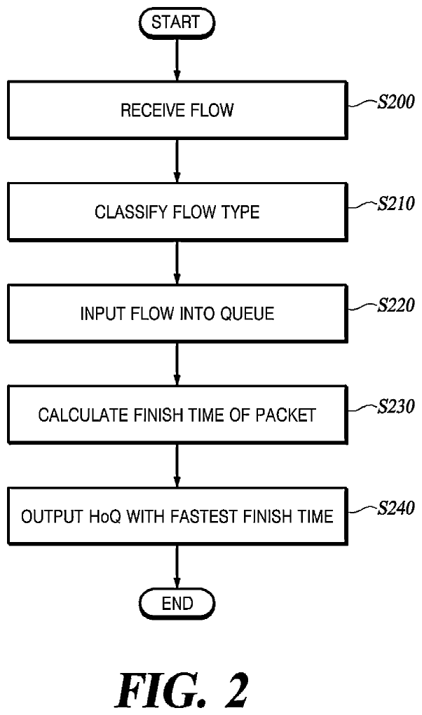

FIG. 2 is a flow chart illustrating a scheduling method according to one embodiment of the present disclosure.

Referring to FIG. 2, the input port 100 receives the flow from another node (S200). The flow includes at least one packet.

The flow type classifier 120 classifies the flow received by the input port 100 by type (S210). For example, the flow may be classified using the maximum burst size.

The flow classified by the flow type classifier (120) is input into the queue (S220). The queue may be, for example, a FIFO queue. One queue can be assigned to each flow type.

The scheduler 130 calculates the finish time of each packet entered into each queue (S230). The finish time of the packet may be calculated, for example, using the global finish time and finish time update value of the other node.

The scheduler 130 compares the finish times of the HoQ packets in each queue and outputs the HoQ packet with the earliest finish time (S240).

Although the flowchart illustrated in FIG. 2 depicts processes as being performed in a pre-determined order, the processes do not have to be performed in that pre-determined order, and the order of all or part of the depicted processes may be changed and performed.

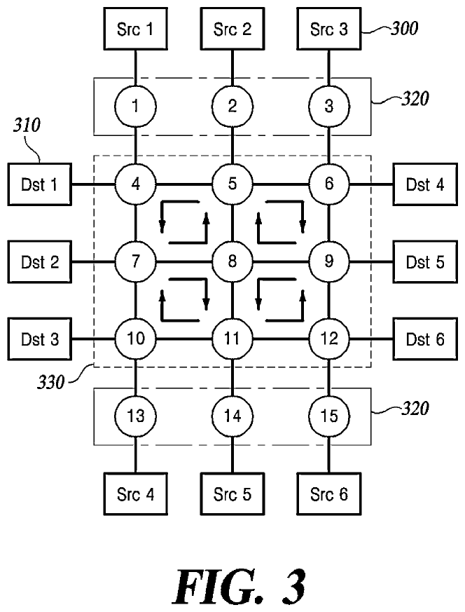

FIG. 3 illustrates a network configuration diagram according to one embodiment of the present disclosure.

Referring to FIG. 3, a network according to one embodiment of the present disclosure includes six sources 300, destinations 310, and entrance nodes 320, respectively. The network according to one embodiment of the present disclosure includes nine relay nodes 330. The link capacity is 1 Gbps. The source 300 generates a total of six flows, two for each flow type. The entrance node 320 each uses 6 FIFO queues.

Nodes 1, 2, 3, 13, 14, and 15 in FIG. 3 represent the entrance nodes 320. Nodes 4, 5, 6, 7, 8, 9, 10, 11, and 12 represent the relay nodes 330.

Table 2 illustrates the characteristics of each type of flow included in the network configuration diagram of FIG. 3.

TABLE 2

| Flow type | Maximum burst size | Packet length | Destination |
|---|---|---|---|
| A | 200Kbit | 1K-10Kbit | 1, 6 |
| B | 200Kbit | 1K-10Kbit | 3, 4 |
| C | 20Kbit | 1K-2Kbit | 2, 5 |

Flows with a flow type of C (hereinafter, referred to as “C-type flows”) have a high service rate. However, the C-type flows have a small maximum burst size and packet length, so they may suffer relative losses if they receive the same service as other types of flows. Therefore, the C-type flows need protection.

The relay node 330 illustrated in FIG. 3 may be a scheduling device that uses one FIFO queue for each input port 100, a scheduling device that uses one PIFO queue for each input port 100, or a scheduling device that uses one FIFO queue for each flow type.

Table 3 illustrates the path passing the largest number of hops for each flow type included in the network configuration diagram of FIG. 3.

TABLE 3

| Flow type | Path with the highest number of hops |
|---|---|
| A | Scr5-14-11-10-7-8-5-4-Dst1 |
| | Scr2-2-5-6-9-8-11-12-Dst6 |
| B | Scr5-14-11-10-7-8-5-4-Dst4 |
| | Scr2-2-5-6-9-8-11-10-Dst3 |
| C | Scr3-3-6-9-8-5-4-7-Dst2 |
| | Scr6-15-12-9-8-5-4-7-Dst2 |
| | Scr1-1-4-7-8-11-12-9-Dst5 |
| | Scr4-13-10-7-8-11-12-9-Dst5 |

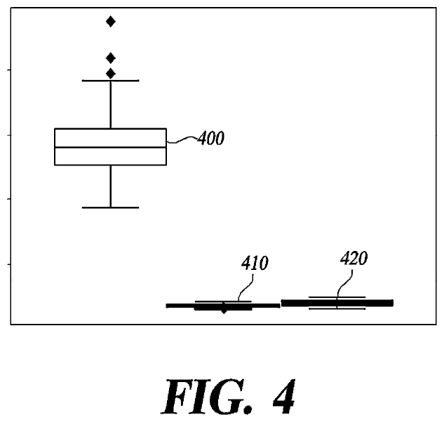

FIG. 4 is a graph illustrating simulation results using the network configuration illustrated in FIG. 3. The graph in FIG. 4 illustrates the distribution of maximum end-to-end latency of the C-type flow. The simulation in FIG. 4 was performed in an environment with 90% utilization. A vertical axis of FIG. 4 represents the distribution of the maximum end-to-end latency.

FIG. 4 illustrates the distribution of the maximum end-to-end latency of the relay node including a scheduling device 400 using one FIFO queue for each input port, a scheduling device 410 using one PIFO queue for each input port, or a scheduling device 420 using one FIFO queue for each flow type.

In the case of the scheduling device (400) that uses the PIFO queue for each input port or a scheduling device 410 that uses a FIFO queue for each input port, the relay node uses two queues. When using the queues for each flow type, the relay node uses three queues.

The scheduling device 400, which uses one FIFO queue for each input port, has a high end-to-end latency. In comparison, the scheduling device 410, which uses one PIFO queue for each input port, and the scheduling device 420, which uses one FIFO queue for each flow type, have a low end-to-end latency. The lower end-to-end latency means that the flow is better protected than when end-to-end latency is high.

In other words, the C-type flow is better protected in the node that uses the scheduling device 420 that uses one FIFO queue for each flow type than in the node that includes the scheduling device 400 that uses one FIFO queue in each input port.

Considering the high difficulty of implementing PIFO queue, the relay node including the scheduling device 110 according to the present disclosure is easy to implement and can protect the flow.

In other words, a node that classifies flows by flow type can protect flows better than a node that classifies flows by input port, and is easier to implement than a node that allocates a queue by flow or a node that uses a PIFO queue.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. An apparatus for packet scheduling, the apparatus comprising:
a flow type classifier configured to classify a flow by type and to allocate at least one queue to each flow type; and
a scheduler configured to calculate finish times of packets in the queue and to compare finish times of HoQ packets in the queue with each other to output an HoQ packet with an earliest finish time.

2. The apparatus of claim 1, wherein the flow type classifier includes a first classifier configured to classify a flow type using service rate, and a second classifier configured to classify the flow type using a maximum burst size.

3. The apparatus of claim 2, wherein the first classifier classifies the flow type into a flow type with a service rate higher than a pre-determined value, and a flow type with a service rate lower than or equal to the pre-determined value.

4. The apparatus of claim 2, wherein the first classifier classifies the flow type using QoS priorities.

5. The apparatus of claim 2, wherein the second classifier classifies the flow type into a flow type with a maximum burst size greater than a pre-determined value, and a flow type with a maximum burst size smaller than or equal to the pre-determined value.

6. The apparatus of claim 2, wherein the second classifier classifies the flow type using QoS priorities.

7. The apparatus of claim 1, wherein the flow type classifier classifies a flow requiring a service rate and a maximum burst size into a flow type with high priority.

8. The apparatus of claim 1, wherein one queue is allocated to each flow type, and the queue is a FIFO queue.

9. A method for packet scheduling by a scheduling apparatus, the method comprising:
classifying at least one flow by type;
allocating at least one queue to each flow type;
calculating a finish time of each packet in the queue; and
comparing finish times of HoQ packets in the queue and transmitting a HoQ packet with an earliest finish time.

10. The method of claim 9, wherein the classifying the flow by type comprises:
firstly classifying the flow type using a service rate, and
secondly classifying the flow type using a maximum burst size.

11. The method of claim 10, wherein the first classifying is classifying the flow type into a flow type with a service rate greater than a pre-determined value and a flow type with a service rate lower than or equal to the pre-determined value.

12. The method of claim 10, wherein the first classifying is classifying the flow type using QoS priorities.

13. The method of claim 10, wherein the second classifying is classifying the flow type into a flow type with a maximum burst size greater than a pre-determined value, and a flow type with a maximum burst size smaller than or equal to the pre-determined value.

14. The method of claim 10, wherein the second classifying is classifying the flow type using QoS priorities.

15. The method of claim 10, wherein the classifying the flow by type is classifying a flow requiring a service rate and maximum burst size into a flow type with high priority.

16. The method of claim 9, wherein one queue is allocated to each flow type, and the queue is a FIFO queue.
